(19) United States
(12) Patent Application Publication
(10) Pub. No.: US 2025/0118288 A1
(43) Pub. Date: Apr. 10, 2025

(54) METHOD FOR PROCESSING AUDIO DATA, ELECTRONIC DEVICE AND STORAGE MEDIUM

(71) Applicant: APOLLO INTELLIGENT CONNECTIVITY (BEIJING) TECHNOLOGY CO., LTD., Beijing (CN)

(72) Inventor: Wenqiang Mao, Beijing (CN)

(73) Assignee: APOLLO INTELLIGENT CONNECTIVITY (BEIJING) TECHNOLOGY CO., LTD., Beijing (CN)

(21) Appl. No.: 18/910,975

(22) Filed: Oct. 9, 2024

(30) Foreign Application Priority Data
Oct. 10, 2023 (CN) 202311309889.7

(51) Int. Cl. G10L 15/02; G10L 15/08

(52) U.S. Cl. CPC G10L 15/02; G10L 15/08; G10L 2015/088

(57) ABSTRACT

A method for processing audio data includes: obtaining audio data, and obtaining a key frame of the audio data by performing keyword detection on the audio data; determining a second speech application based on the key frame, and sending a frame identifier of the key frame to the second speech application; and extracting first audio data from the audio data according to the key frame, and sending the first audio data to the second speech application for speech recognition.

### CROSS-REFERENCE TO RELATED APPLICATION

This application claims priority to and benefits of Chinese Patent Application Serial No. 202311309889.7, filed with the State Intellectual Property Office of P. R. China on Oct. 10, 2023, the entire content of which is incorporated herein by reference.

### TECHNICAL FIELD

The disclosure relates to a field of audio processing technologies, in particular to a method for processing audio data, an apparatus for processing audio data, an electronic device and a storage medium.

### BACKGROUND

In the related art, most products integrate the functions of speech detection and recognition into the same application. In a case where there are multiple applications on a device and each application requires separate speech detection and recognition.

### SUMMARY

According to a first aspect of embodiments of the disclosure, a method for processing audio data is provided. The method, performed by a first speech application, includes: obtaining audio data, and obtaining a key frame of the audio data by performing keyword detection on the audio data; determining a second speech application based on the key frame, and sending a frame identifier of the key frame to the second speech application; and extracting first audio data from the audio data according to the key frame, and sending the first audio data to the second speech application for speech recognition.

According to a second aspect of embodiments of the disclosure, a method for processing audio data is provided. The method, performed by a second speech application includes: receiving a frame identifier of a key frame of audio data sent by a first speech application; receiving first audio data sent by the first speech application, the first audio data being extracted from the audio data based on the key frame; and determining second audio data from the first audio data based on the frame identifier of the key frame, and obtaining a speech recognition result by performing speech recognition on the second audio data.

According to a third aspect of embodiments of the disclosure, an electronic device is provided. The electronic device includes: at least one processor and a memory communicatively coupled to the at least one processor. The memory stores instructions executable by the at least one processor. When the instructions are executed by the at least one processor, the at least one processor is caused to implement the method for processing audio data described in any embodiment of the disclosure.

According to a fourth aspect of embodiments of the disclosure, a non-transitory computer-readable storage medium having computer programs/instructions stored thereon is provided. The computer programs/instructions are used to cause a computer to implement the method for processing audio data described in any embodiment of the disclosure.

It should be understood that the content described in this section is not intended to identify key or important features of the embodiments of the disclosure, nor is it intended to limit the scope of the disclosure. Additional features of the disclosure will be easily understood from the following description.

### BRIEF DESCRIPTION OF THE DRAWINGS

The accompanying drawings are used to better understand this solution and do not constitute a limitation to the disclosure, in which:

FIG. 1 is a flowchart of a method for processing audio data provided by an embodiment of the disclosure.

FIG. 2 is a flowchart of a method for processing audio data provided by an embodiment of the disclosure.

FIG. 3 is a flowchart of a method for processing audio data provided by an embodiment of the disclosure.

FIG. 4 is a flowchart of a method for processing audio data provided by an embodiment of the disclosure.

FIG. 5 is a schematic diagram illustrates first audio data and second audio data provided by an embodiment of the disclosure.

FIG. 6 is a schematic diagram illustrates interaction in a method for processing audio data provided by an embodiment of the disclosure.

FIG. 7 is a schematic diagram of a process of detecting and recognizing audio data provided by an embodiment of the disclosure.

FIG. 8 is a schematic diagram of an apparatus for processing audio data provided by an embodiment of the disclosure.

FIG. 9 is a schematic diagram of an apparatus for processing audio data provided by an embodiment of the disclosure.

FIG. 10 is a block diagram of an electronic device used to implement the method for processing audio data provided by an embodiment of the disclosure.

### DETAILED DESCRIPTION

The following description of exemplary embodiments of the disclosure is provided in combination with the accompanying drawings, which includes various details of the embodiments of the disclosure to aid in understanding, and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following description.

A method for processing audio data, an apparatus for processing audio data, an electronic device and a storage medium are described below with reference to the accompanying drawings.

Artificial intelligence (AI) is a subject that studies to enable computers to simulate certain thought processes and intelligent behaviors (e.g., learning, reasoning, thinking, planning, etc.) of human beings, which involves techniques both at the hardware level and at the software level. AI hardware technology generally includes computer vision technology, speech recognition technology, natural language processing technology and learning/deep learning, big data processing technology, knowledge graph technology and other aspects.

Natural language processing (NLP) is an important direction in the fields of computer science and AI. It studies various theories and methods that can realize effective communication between human and a computer in natural language. NLP is a science that integrates linguistics, computer science and mathematics. NLP is mainly applied to machine translation, public opinion monitoring, automatic summarization, viewpoint extraction, text classification, question answering, text semantic comparison, speech recognition, etc.

Deep learning (DL) is a new research direction in the field of machine learning (ML), which has been introduced into ML to bring it closer to its original goal of AI. DL learns the intrinsic rules and representation levels of sample data, and information gained from the learning process can be very helpful in interpreting data such as texts, images, and sounds. Its ultimate goal is to enable machines to have the same analytical learning capabilities as humans and be able to recognize data such as texts, images and sounds. DL is a complex ML algorithm that has achieved far greater results in speech and image recognition than previous related techniques.

Intelligent searching is a new generation of search engine integrating AI technology. It not only provides traditional functions such as quick search and relevance sorting, but also provides functions such as user role registration, user interest automatic recognition, semantic understanding of content, intelligent information filtering and pushing.

Speech technology aims to enable the computers to listen, see, speak and feel. It is a future direction of human-computer interaction. Speech becomes the most favored future human-computer interaction, because it has more advantages than other interaction methods. Speech synthesis technology is required to enable the computers to speak, and its core is text-to-speech technology.

Machine translation, also known as automatic translation, is a process of converting one natural language (source language) into another natural language (target language) using a computer. It is a branch of computational linguistics and is also one of the goals of AI.

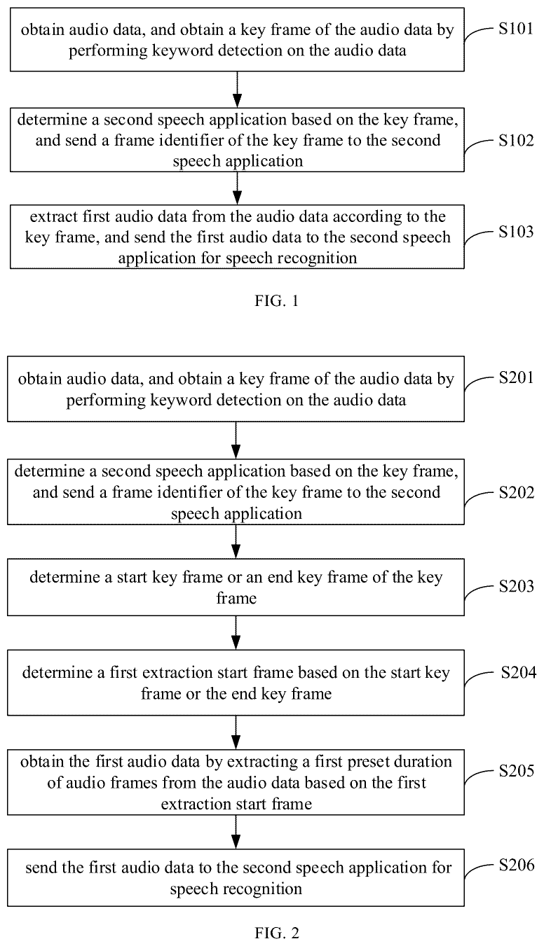

FIG. 1 is a flowchart of a method for processing audio data provided by an embodiment of the disclosure.

As illustrated in FIG. 1, the method for processing audio data includes the following steps.

At step S101, audio data is obtained, and a key frame of the audio data is obtained by performing keyword detection on the audio data.

It is noted that the execution subject of the method for processing audio data in the embodiments of the disclosure may be a hardware device having an audio data processing capability and/or necessary software required to drive the hardware device to operate. Optionally, the execution subject may include an in-vehicle terminal, a user equipment, and other intelligent devices. Optionally, the user equipment includes, but is not limited to, a cell phone, a computer, a smart speech interaction device, etc., which is not limited in the embodiments of the disclosure.

In some implementations, speech information can be monitored. The audio data can be captured by a microphone in response to detecting the speech information of a user. For example, for the in-vehicle terminal, a first speech application may collect the audio data based on one or more microphones of the vehicle, or a microphone array of the vehicle. The first speech application may be a native speech application of the in-vehicle terminal.

In some implementations, the first speech application may perform keyword detection on the audio data based on a keyword. The keyword is a wake-up word of a second speech application. Optionally, the keyword may be determined according to the wake-up word provided by the second speech application. The wake-up word of the second speech application may be set by the user and used as the keyword.

In some implementations, the keyword in the audio data can be detected based on a keyword detection algorithm. When the keyword in the audio data is detected, an audio frame corresponding to the keyword may be used as the key frame of the audio data. Optionally, the key frame of the audio data may be obtained by determining a start frame number and an end frame number of the audio data corresponding to the keyword.

At step S102, a second speech application is determined based on the key frame, and a frame identifier of the key frame is sent to the second speech application.

It is understood that if the key frame includes the keyword, also known as the wake-up word, of a second speech application, the corresponding second speech application can be determined based on the keyword. For example, for the in-vehicle terminal, the second speech application may be a vehicle-device smart interaction product of a third-party, and there may be one or more second speech applications on the in-vehicle terminal.

In some implementations, the frame identifier of the key frame may be sent to the second speech application based on a communication link between the first speech application and the second speech application. Optionally, the frame identifier of the key frame may be sent to the second speech application based on Android interface definition language (AIDL) communication.

In some implementations, a frame identification symbol can be used to identify the key frame to distinguish the key frame from other frames, and the frame identification symbol of the key frame may be sent as the frame identifier of the key frame to the second speech application over the communication link.

At step S103, first audio data is extracted from the audio data according to the key frame, and the first audio data is sent to the second speech application for speech recognition.

In some implementations, the first audio data may be extracted from the audio data based on information such as the number of frames in the key frame. The first audio data is audio data of a first preset duration, which may or may not include the key frame. That is, the first audio data of the first preset duration may be extracted from the audio data based on any one of the start key frame and the end key frame of the key frame.

Optionally, the first audio data of the first preset duration may also be extracted from the audio data by moving forward or backward a preset number of frames from the start key frame of the key frame. The first audio data of the first preset duration may also be extracted from the audio data by moving forward or backward a preset number of frames from the end key frame of the key frame.

Optionally, a start frame and an end frame of the first audio data may be determined based on recognition configuration information of the second speech application, to extract the first audio data from the audio data.

The first audio data may be sent to the second speech application based on the communication link between the first speech application and the second speech application for the second speech application to perform the speech recognition, to answer a question raised by the user, thereby satisfying the user' needs.

With the method for processing audio data according to embodiments of the disclosure, the first speech application obtains the audio data by capturing the speech of the user, detects the keyword in the audio data and obtains the key frame of the audio data, and sends the frame identifier of the key frame to the second speech application corresponding to the key frame. According to the number of frames in the key frame, the first audio data is extracted from the audio data and sent to the second speech application for performing speech recognition on the first audio data. By decoupling keyword detection and speech recognition into two applications for implementation, diversified audio data processing can be achieved, and the configurability and flexibility of processing audio data can be improved. When multiple second speech applications are adopted, computing power can be reduced to avoid waste of resources.

FIG. 2 is a flowchart of a method for processing audio data provided by an embodiment of the disclosure.

As illustrated in FIG. 2, the method for processing audio data includes the following steps.

At step S201, audio data is obtained, and a key frame of the audio data is obtained by performing keyword detection on the audio data.

Relevant contents of step S201 can be referred to the above embodiments and will not be repeated here.

At step S202, a second speech application is determined based on the key frame, and frame identifier of the key frame is sent to the second speech application.

Relevant contents relating to determining the second speech application at step S201 can be referred to the above embodiments and will not be repeated here.

In some implementations, a communication link between the first speech application and the second speech application can be pre-established to transmit data and information between the applications and to enable collaboration between the applications, thereby improving the functionality of the applications. The communication link is used for transmitting the frame identifier of the key frame and the first audio data. Optionally, AIDL communication can be established for transmitting the frame identifier of the key frame and the first audio data.

In some implementations, the key frame can be determined based on a first frame identifier of a start key frame, a number of frames in the key frame and a second frame identifier of an end key frame. The first frame identifier of the start key frame and the number of frames in the key frame may be sent to the second speech application, and the second frame identifier of the end key frame in the key frame may also be sent to the second speech application.

At step S203, a start key frame or an end key frame of the key frame is determined.

At step S204, a first extraction start frame is determined based on the start key frame or the end key frame.

In some implementations, the start key frame or the end key frame may be determined from the key frame based on the first frame identifier or the second frame identifier. The first extraction start frame is determined based on the start key frame or the end key frame.

Optionally, any one of the start key frame and the end key frame can be determined as the first extraction start frame. Optionally, the first extraction start frame is obtained by moving forward or backward a first preset number of frames from either the start key frame or the end key frame. Therefore, precise positioning of the first audio data is realized, and loss and misalignment of the audio data is avoided.

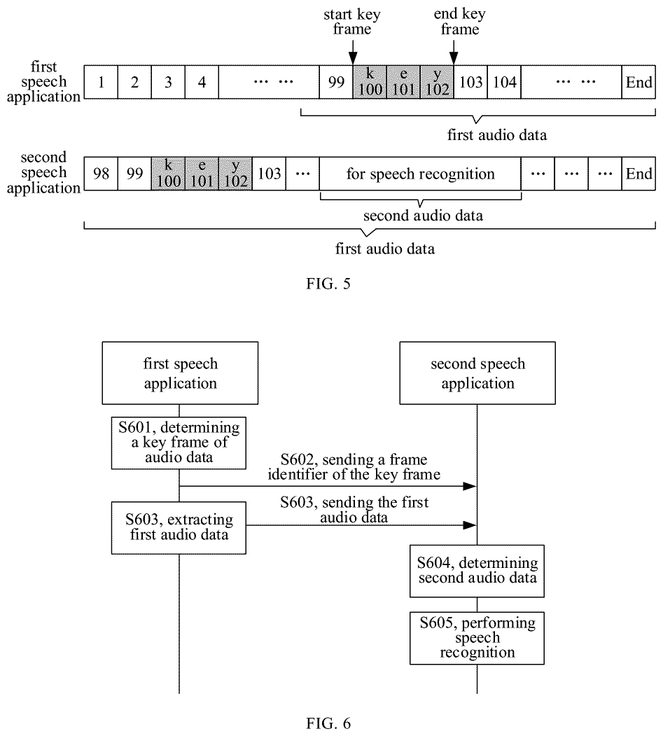

For example, for the audio data shown in FIG. 5, the key frame is represented by key, a start key frame is 100, and an end key frame is 102, either 100 or 102 may be determined as the first extraction start frame. If the first preset number of frames is 1, any one of 99, 101 or 103 may be determined as the first extraction start frame.

Optionally, the first extraction start frame may be determined based on recognition configuration information of the second speech application. By obtaining the recognition configuration information of the second speech application, a target key frame can be determined from the start key frame and the end key frame based on the recognition configuration information, and the first extraction start frame is determined based on the target key frame. In this way, precise positioning of the first audio data is realized, and loss and misalignment of the audio data is avoided.

For example, according to the audio data illustrated in FIG. 5, the key frame is represented by key, and it is determined that the target key frame is 100 based on the recognition configuration information of the second speech application, and thus the first extraction start frame is determined as 100.

At step S205, the first audio data is obtained by extracting a first preset duration of audio frames from the audio data based on the first extraction start frame.

In some implementations, by setting a duration of the first audio data, the first audio data can be obtained by capturing the preset duration from the audio data based on the first extraction start frame.

Optionally, the first preset duration may be a fixed duration, e.g., 8 seconds, or a duration dynamically set based on the requirements of the second speech application. For example, if the second speech application A requires a 10 seconds audio, the first preset duration is 10 seconds. If the second speech application B requires an 8 seconds audio, the first preset duration is 8 seconds.

In some implementations, the first audio data is obtained by perform extraction on the audio data based on the first extraction start frame and the first preset duration.

For example, according to the audio data illustrated in FIG. 5, the key frame is represented as key, the start key frame is 100, and the end key frame is 102. Starting from the start key frame, a first extraction start frame, i.e., 98, is obtained by moving backward for a first preset number (i.e., 2) of frames. The first preset duration is 5 seconds, and the first audio data is from the 98^{th} frame to the end frame of the audio data.

At step S206, the first audio data is sent to the second speech application for speech recognition.

Relevant contents of step S206 can be referred to the above embodiments and will not be repeated here.

With the method for processing audio data according to embodiments of the disclosure, the first speech application obtains the audio data by capturing the speech of the user, detects the keyword in the audio data and obtains the key frame of the audio data, and sends the frame identifier of the key frame to the second speech application corresponding to the key frame through the communication link. The first extraction start frame is determined according to the start key frame or the end key frame in the key frame. The first audio data is extracted from the audio data based on the first preset duration and is sent to the second speech application for speech recognition. By decoupling keyword detection and speech recognition into two applications for implementation, diversified audio data processing can be achieved, and the configurability and flexibility of processing audio data can be improved. When multiple second speech applications are adopted, computing power can be reduced to avoid waste of resources.

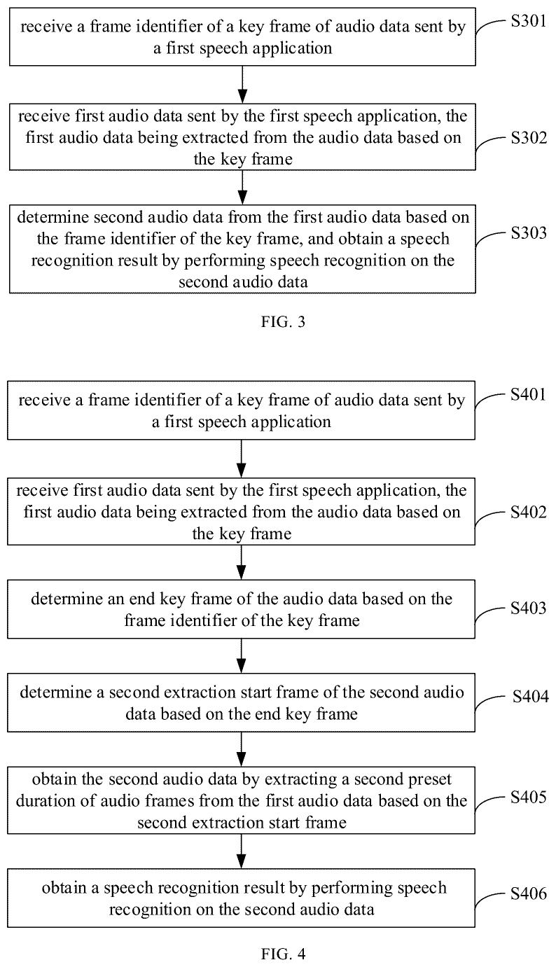

FIG. 3 is a flowchart of a method for processing audio data provided by an embodiment of the disclosure.

As illustrated in FIG. 3, the method for processing audio data includes the following steps.

At step S301, a frame identifier of a key frame of audio data sent by a first speech application are received.

In some implementations, a communication link between the first speech application and a second speech application can be pre-established to transmit data and information between each the applications and to enable collaboration between the applications, thereby improving the functionality of the applications. The communication link is used for transmitting the frame identifier of the key frame and the first audio data. Optionally, the communication link with the first speech application may be established based on AIDL communication.

In some implementations, based on the established communication link, a first frame identifier of a start key frame of the key frame and the number of frames in the key frame sent by the first speech application may be received, and a second frame identifier of an end key frame in the key frame sent by the first speech application may also be received, so that the second speech application can quickly and accurately locate the key frame to improve the efficiency of data transmission.

At step S302, first audio data sent by the first speech application is received, the first audio data being extracted from the audio data based on the key frame.

In some implementations, the second speech application may receive the first audio data sent by the first speech application on the established communication link. The first audio data is extracted from the audio data based on the key frame. The first audio data is audio data of a first preset duration, and the first audio data may or may not contain the key frame.

For example, according to the audio data illustrated in FIG. 5, the first audio data is from the 98^{th} frame to the end frame, and the second speech application receives the first audio data from the first speech application.

At step S303, second audio data is determined from the first audio data based on the frame identifier of the key frame, and a speech recognition result is obtained by performing speech recognition on the second audio data.

In some implementations, the frame identifier of the key frame includes the first frame identifier of the start key frame and the second frame identifier of the end key frame. The second speech application may determine a key frame corresponding to either the first frame identifier or the second frame identifier as a second extraction start frame of the second audio data. Based on the second extraction start frame and a second preset duration of the second audio data, the second audio data can be extracted from the first audio data and used for speech recognition.

Optionally, the second audio data may also be obtained by moving forward from the key frame corresponding to either the first frame identifier or the second frame identifier by a second preset number of frames, to obtain the second extraction start frame of the second audio data. The second audio data is extracted from the first audio data based on the second extraction start frame and the second preset duration.

For example, according to the first audio data received by the second speech application illustrated in FIG. 5, a second extraction start frame is obtained by moving forward by a second preset number of frames from a key frame corresponding to the second frame identifier, i.e., the end key frame of the key frame,, and the second audio data is obtained by extracting from the first audio data based on the second preset duration.

The second speech application may perform speech recognition on the second audio data and obtain a speech recognition result. Optionally, the recognition result may be obtained by converting the second audio data to text data and performing semantic recognition on the text data. Optionally, the second audio data may be converted to the text data through automatic speech recognition (ASR).

With the method for processing audio data according to embodiments of the disclosure, the second speech application receives the frame identifier of the key frame of the audio data and the first audio data sent by the first speech application, extracts the second audio data used for speech recognition from the first audio data based on the frame identifier of the key frame, and performs speech recognition on the second audio data and obtains the speech recognition result. By decoupling keyword detection and speech recognition into two applications for implementation, diversified audio data processing can be achieved, and the configurability and flexibility of processing audio data can be improved. When multiple second speech applications are adopted, computing power can be reduced to avoid waste of resources.

FIG. 4 is a flowchart of a method for processing audio data provided by an embodiment of the disclosure.

As illustrated in FIG. 4, the method for processing audio data includes the following steps.

At step S401, a frame identifier of a key frame of audio data sent by a first speech application are received.

At step S402, first audio data sent by the first speech application is received, the first audio data being extracted from the audio data based on the key frame.

Relevant contents of steps S401-S402 can be referred to the above embodiments and will not be repeated here.

At step S403, an end key frame of the audio data is determined based on the frame identifier of the key frame.

In some implementations, the frame identifier of the key frame includes the first frame identifier of the start key frame and the second frame identifier of the end key frame. The end key frame of the audio data is determined based on the first frame identifier of the start key frame in the key frame and the number of frames in the key frame. The end key frame of the audio data may also be determined based on the second frame identifier of the end key frame in the key frame.

Optionally, an endpoint, i.e., the end key frame, of the key frame can be calculated according to the first frame identifier and the number of frames in the key frame. The endpoint, i.e., the end key frame, of the key frame can also be calculated according to the second frame identifier. If the first audio data does not include the key frame, the end key frame of the audio data can be determined based on the key frame identifier.

At step S404, a second extraction start frame of the second audio data is determined based on the end key frame of the audio data.

In some implementations, when determining the second extraction start frame based on the end key frame of the audio data, the key content can be accurately captured to improve the extraction efficiency, and time and computational resources can be saved by directly extracting the key portion.

Optionally, the end key frame of the audio data is used as the second extraction start frame. The second extraction start frame can be obtained by moving forward by a second preset number of frames from the end key frame of the audio data.

At step S405, the second audio data is obtained by extracting a second preset duration of audio frames from the first audio data based on the second extraction start frame.

In some implementations, by setting a duration of the second audio data, the second audio data may be obtained by extraction from the first audio data based on the second extraction start frame.

Optionally, the second preset duration may be a fixed duration, e.g., 5 seconds, or a duration dynamically set based on the requirements of the second speech application. For example, if the second speech application A requires a second audio data of 3 seconds, the second preset duration is 3 seconds. If the second speech application B requires an audio of 5 seconds, the second preset duration is 5 seconds.

In some implementations, the second audio data is obtained by extracting from the first audio data based on the second extraction start frame and the second preset duration. For example, according to the first audio data illustrated in FIG. 5, the second extraction start frame is set to be 104, and the second audio data is extracted from the first audio data based on the second preset duration.

At step S406, a speech recognition result is obtained by performing speech recognition on the second audio data.

Relevant contents of step S406 can be referred to the above embodiments and will not be repeated here.

FIG. 5 is a schematic diagram illustrates the first audio data and the second audio data. The first speech application obtains the audio data and determines the key frame from the audio data by performing keyword detection on the audio data. The start key frame of the key frame (key shown in FIG. 5) is 100 and the end key frame is 102. If it is determined that the first extraction start frame is 98, the first audio data which is from the 98^{th} frame to the end frame can be obtained based on the first extraction start frame and the first preset duration. The second extraction start frame is obtained by moving forward by a second preset number of frames, e.g., 2 frames, from the end key frame. Based on the second extraction start frame, the second audio data is extracted from the first audio data based on a second preset duration of audio frames. The speech recognition result can be obtained by performing speech recognition on the second audio data.

With the method for processing audio data according to embodiments of the disclosure, the second speech application receives the frame identifier of the key frame of the audio data and the first audio data sent by the first speech application, extracts the second audio data used for speech recognition from the first audio data based on the frame identifier of the key frame, and performs speech recognition on the second audio data to obtain the speech recognition result. By decoupling keyword detection and speech recognition into two applications for implementation, diversified audio data processing can be achieved, and the configurability and flexibility of processing audio data can be improved. When multiple second speech applications are adopted, computing power can be reduced to avoid waste of resources.

FIG. 6 is a schematic diagram illustrates a method for processing audio data provided by an embodiment of the disclosure.

As illustrated in FIG. 6, the method for processing audio data includes the following steps.

At step S601, a first speech application obtains audio data and a key frame of the audio data.

At step S602, the first speech application sends a frame identifier of the key frame to the second speech application.

At step S603, the first speech application extracts first audio data from the audio data and sends the first audio data to a second speech application.

At step S604, the second speech application determines second audio data from the first audio data.

At step S605, the second speech application performs speech recognition on the second audio data.

With the method for processing audio data according to embodiments of the disclosure, the first speech application obtains the audio data by capturing the speech of the user, detects the keyword in the audio data and obtains the key frame of the audio data, and sends the frame identifier of the key frame to the second speech application corresponding to the key frame over the communication link. According to the number of frames in the key frame, the first audio data is extracted from the audio data and sent to the second speech application for speech recognition. By decoupling keyword detection and speech recognition into two applications for implementation, diversified audio data processing can be achieved, and the configurability and flexibility of processing audio data can be improved. When multiple second speech applications are adopted, computing power can be reduced to avoid waste of resources.

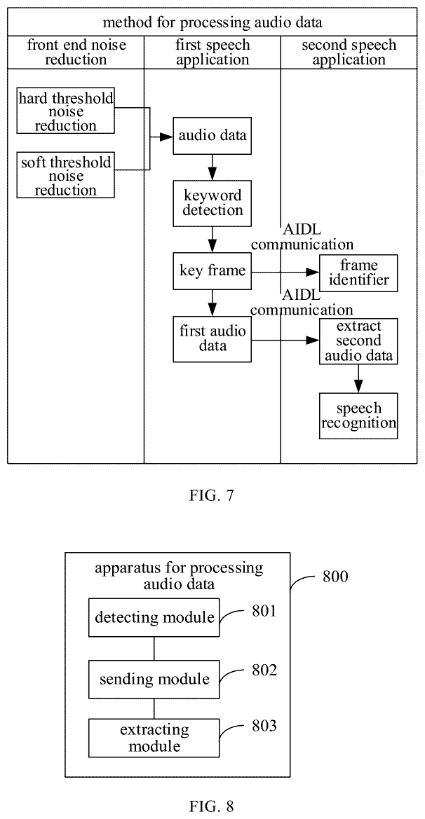

FIG. 7 is a schematic diagram of a process of detecting and recognizing audio data provided by an embodiment of the disclosure. In order to reduce the interference of external noise and improve the correct rate of subsequent audio detection and recognition, the audio data is obtained by performing noise reduction on the captured speech of the user. The first speech application performs keyword detection on the audio data to obtain the key frame of the audio data, and sends the frame identifier of the key frame to the second speech application via AIDL communication. The first speech application can extract the first audio data from the audio data according to the key frame and send the first audio data to the second speech application via AIDL communication. The second speech application extracts the second audio data from the first audio data and performs speech recognition on the second audio data to obtain the recognition result.

Corresponding to the method for processing audio data provided in the above-described embodiments, embodiments of the disclosure also provide an apparatus for processing audio data. Since the apparatus for processing audio data provided in the embodiments of the disclosure corresponds to the method for processing audio data provided in the above-described embodiments, the above-described implementations of the method for processing audio data are also applicable to the apparatus for processing audio data provided in the embodiments of the disclosure, which will not be described in detail in the following embodiments.

FIG. 8 is a schematic diagram of an apparatus for processing audio data provided by an embodiment of the disclosure.

As illustrated in FIG. 8, the apparatus 800 for processing audio data in the embodiment of the disclosure includes: a detecting module 801, a sending module 802, and an extracting module 803.

The detecting module 801 is configured to obtain audio data, and obtain a key frame of the audio data by performing keyword detection on the audio data.

The sending module 802 is configured to determine a second speech application based on the key frame, and send a frame identifier of the key frame to the second speech application.

The extracting module 803 is configured to extract first audio data from the audio data according to the key frame, and send the first audio data to the second speech application for speech recognition.

In an embodiment of the disclosure, the sending module 802 is further configured to: send a first frame identifier of a start key frame in the key frame and a number of frames in the key frame to the second speech application; or send a second frame identifier of an end key frame in the key frame to the second speech application.

In an embodiment of the disclosure, the extracting module 803 is further configured to: determine a start key frame or an end key frame of the key frame; determine a first extraction start frame based on the start key frame or the end key frame; and obtain the first audio data by extracting a first preset duration of audio frames from the audio data based on the first extraction start frame.

In an embodiment of the disclosure, the extracting module 803 is further configured to: determine any one of the start key frame and the end key frame as the first extraction start frame; or determine the first extraction start frame by moving forward or backward a first preset number of frames from either the start key frame or the end key frame.

In an embodiment of the disclosure, the extracting module 803 is further configured to: obtain recognition configuration information of the second speech application; and determine a target key frame from the start key frame and the end key frame based on the recognition configuration information, and determine the first extraction start frame based on the target key frame.

In an embodiment of the disclosure, the sending module 802 is further configured to: establish a communication link with the second speech application, in which the communication link is used to transmit the frame identifier of the key frame and the first audio data.

With the method for processing audio data according to embodiments of the disclosure, the first speech application obtains the audio data by capturing the speech of the user, detects the keyword in the audio data and obtains the key frame of the audio data, and sends the frame identifier of the key frame to the second speech application corresponding to the key frame. According to the number of frames in the key frame, the first audio data is extracted from the audio data and sent to the second speech application for speech recognition. By decoupling keyword detection and speech recognition into two applications for implementation, diversified audio data processing can be achieved, and the configurability and flexibility of processing audio data can be improved. When multiple second speech applications are adopted, computing power can be reduced to avoid waste of resources.

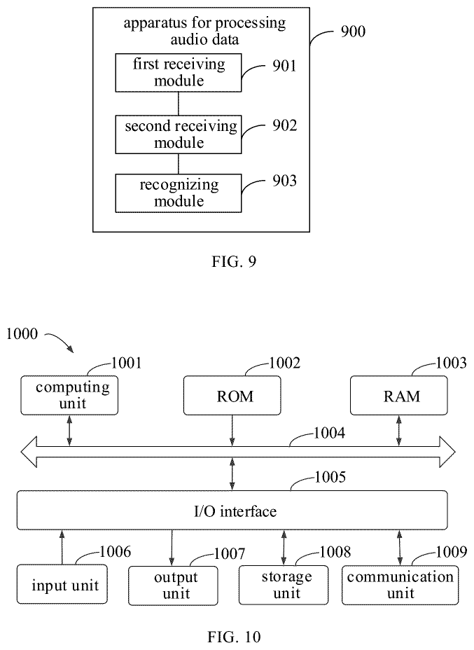

FIG. 9 is a schematic diagram of an apparatus for processing audio data provided by an embodiment of the disclosure.

As illustrated in FIG. 9, the apparatus 900 for processing audio data in the embodiment of the disclosure includes: a first receiving module 901, a second receiving module 902, and a recognizing module 903.

The first receiving module 901 is configured to receive a frame identifier of a key frame of audio data sent by a first speech application.

The second receiving module 902 is configured to receive first audio data sent by the first speech application, the first audio data being extracted from the audio data based on the key frame.

The recognizing module 903 is configured to determine second audio data from the first audio data based on the frame identifier of the key frame, and obtain a speech recognition result by performing speech recognition on the second audio data.

In an embodiment of the disclosure, the first receiving module 901 is further configured to: receive a first frame identifier of a start key frame in the key frame and a number of frames of the key frame sent by the first speech application; or receive a second frame identifier of an end key frame in the key frame sent by the first speech application.

In an embodiment of the disclosure, the recognizing module 903 is further configured to: determine an end key frame of the audio data based on the frame identifier of the key frame; determine a second extraction start frame of the second audio data based on the end key frame; and obtain the second audio data by extracting a second preset duration of audio frames from the first audio data based on the second extraction start frame.

In an embodiment of the disclosure, the recognizing module 903 is further configured to: determine the end key frame of the audio data based on the first frame identifier of the start key frame of the key frame and the number of frames of the key frame; or determine the end key frame of the audio data based on the second frame identifier of the end key frame in the key frame.

In an embodiment of the disclosure, the recognizing module 903 is further configured to: determine the end key frame as the second extraction start frame; or obtain the second extraction start frame by moving forward a second preset number of frames from the end key frame.

In an embodiment of the disclosure, the first receiving module 901 is further configured to: establish a communication link with the first speech application, the communication link being used to transmit the frame identifier of the key frame and the first audio data.

With the method for processing audio data according to embodiments of the disclosure, the second speech application receives the frame identifier of the key frame of the audio data and the first audio data sent by the first speech application, extracts the second audio data used for speech recognition from the first audio data based on the frame identifier of the key frame, and performs speech recognition on the second audio data to obtain the speech recognition result. By decoupling keyword detection and speech recognition into two applications for implementation, diversified audio data processing can be achieved, and the configurability and flexibility of processing audio data can be improved. When multiple second speech applications are adopted, computing power can be reduced to avoid waste of resources.

The collection, storage, and application of the user's personal information involved in the technical solutions of the disclosure are all in compliance with relevant laws and regulations and do not violate public order and morality.

According to embodiments of the disclosure, the disclosure also provides an electronic device, a readable storage medium and a computer program product.

FIG. 10 illustrates a schematic diagram of an example electronic device 1000 that can be used to implement embodiments of the disclosure. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile devices, such as a personal digital processor, a cellular phone, a smart phone, a wearable device, and other similar computing devices. The components shown here, their connections and relations, and their functions are merely examples, and are not intended to limit the implementation of the disclosure described and/or required herein.

As illustrated in FIG. 10, the electronic device 1000 includes a computing unit 1001 for performing various appropriate actions and processes based on computer programs/instructions stored in a Read-Only Memory (ROM) 1002 or computer programs/instructions loaded from the storage unit 1008 to a Random Access Memory (RAM) 1003. In the RAM 1003, various programs and data required for the operation of the device 1000 are stored. The computing unit 1001, the ROM 1002, and the RAM 1003 are connected to each other through a bus 1004. An input/output (I/O) interface 1005 is also connected to the bus 1004.

Components in the device 1000 are connected to the I/O interface 1005, including: an input unit 1006, such as a keyboard, a mouse; an output unit 1007, such as various types of displays, speakers; a storage unit 1008, such as a disk, an optical disk; and a communication unit 1009, such as network cards, modems, and wireless communication transceivers. The communication unit 1009 allows the device 1000 to exchange information/data with other devices through a computer network such as the Internet and/or various telecommunication networks.

The computing unit 1001 may be various general-purpose and/or dedicated processing components with processing and computing capabilities. Some examples of the computing unit 1001 include, but are not limited to, a Central Processing Unit (CPU), a Graphics Processing Unit (GPU), various dedicated AI computing chips, various computing units that run ML model algorithms, and a Digital Signal Processor (DSP), and any appropriate processor, controller and microcontroller. The computing unit 1001 executes the various methods and processes described above, such as the method for processing audio data. For example, in some embodiments, the method for processing audio data may be implemented as a computer software program, which is tangibly contained in a machine-readable medium, such as the storage unit 1008. In some embodiments, part or all of the computer programs/instructions may be loaded and/or installed on the device 1000 via the ROM 1002 and/or the communication unit 1009. When the computer program is loaded on the RAM 1003 and executed by the computing unit 1001, one or more steps of the method for processing audio data described above may be executed. Alternatively, in other embodiments, the computing unit 1001 may be configured to perform the method for processing audio data in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These various embodiments may be implemented in one or more computer programs/instructions, the one or more computer programs/instructions may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMs, ROMs, Electrically Programmable Read-Only-Memories (EPROM), flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), the Internet and a block-chain network.

The computer system may include a client and a server. The client and server are generally remote from each other and interacting through a communication network. The client-server relation is generated by computer programs/instructions running on the respective computers and having a client-server relation with each other. The server may be a cloud server, a server of a distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for processing audio data, performed by a first speech application, comprising:
obtaining audio data, and obtaining a key frame of the audio data by performing keyword detection on the audio data;
determining a second speech application based on the key frame, and sending a frame identifier of the key frame to the second speech application; and
extracting first audio data from the audio data according to the key frame, and sending the first audio data to the second speech application for speech recognition.

2. The method of claim 1, wherein sending the frame identifier of the key frame to the second speech application comprises:
sending a first frame identifier of a start key frame in the key frame and a number of frames in the key frame to the second speech application; or
sending a second frame identifier of an end key frame in the key frame to the second speech application.

3. The method of claim 1, wherein extracting the first audio data from the audio data according to the key frame comprises:
determining a start key frame or an end key frame in the key frame;
determining a first extraction start frame based on the start key frame or the end key frame; and
obtaining the first audio data by extracting a first preset duration of audio frames from the audio data based on the first extraction start frame.

4. The method of claim 3, wherein determining the first extraction start frame based on the start key frame or the end key frame comprises:
determining any one of the start key frame and the end key frame as the first extraction start frame; or
determining the first extraction start frame by moving forward or backward a first preset number of frames from either the start key frame or the end key frame.

5. The method of claim 3, wherein determining the first extraction start frame based on the start key frame or the end key frame comprises:
obtaining recognition configuration information of the second speech application; and
determining a target key frame from the start key frame and the end key frame based on the recognition configuration information, and determining the first extraction start frame based on the target key frame.

6. The method of claim 1, before sending the frame identifier of the key frame to the second speech application, further comprising:
establishing a communication link with the second speech application, wherein the communication link is used to transmit the frame identifier of the key frame and the first audio data.

7. A method for processing audio data, performed by a second speech application, comprising:
receiving a frame identifier of a key frame of audio data sent by a first speech application;
receiving first audio data sent by the first speech application, the first audio data being extracted from the audio data based on the key frame; and
determining second audio data from the first audio data based on the frame identifier of the key frame, and obtaining a speech recognition result by performing speech recognition on the second audio data.

8. The method of claim 7, wherein receiving the frame identifier of the key frame of the audio data sent by the first speech application comprises:
receiving a first frame identifier of a start key frame in the key frame and a number of frames in the key frame sent by the first speech application; or
receiving a second frame identifier of an end key frame in the key frame sent by the first speech application.

9. The method of claim 8, wherein determining the second audio data from the first audio data based on the frame identifier of the key frame comprises:
determining an end key frame of the key frame based on the frame identifier of the key frame;
determining a second extraction start frame of the second audio data based on the end key frame; and
obtaining the second audio data by extracting a second preset duration of audio frames from the first audio data based on the second extraction start frame.

10. The method of claim 9, wherein determining the end key frame of the key frame based on the frame identifier of the key frame comprises:
determining the end key frame of the key frame based on the first frame identifier of the start key frame in the key frame and the number of frames in the key frame; or
determining the end key frame of the key frame based on the second frame identifier of the end key frame in the key frame.

11. The method of claim 9, wherein determining the second extraction start frame of the second audio data based on the end key frame comprises:
determining the end key frame as the second extraction start frame; or
obtaining the second extraction start frame by moving forward a second preset number of frames from the end key frame.

12. The method of claim 7, before receiving the frame identifier of the key frame of the audio data sent by the first speech application, further comprising:
establishing a communication link with the first speech application, the communication link being used to transmit the frame identifier of the key frame and the first audio data.

13. An electronic device, comprising:
a processor; and
a memory storing instructions executable by the processor;
wherein the processor is configured to:
obtain audio data, and obtaining a key frame of the audio data by performing keyword detection on the audio data;
determine a second speech application based on the key frame, and send a frame identifier of the key frame to the second speech application; and
extract first audio data from the audio data according to the key frame, and send the first audio data to the second speech application for speech recognition.

14. The electronic device of claim 13, wherein, when sending the frame identifier of the key frame to the second speech application, the processor is configured to:
send a first frame identifier of a start key frame in the key frame and a number of frames in the key frame to the second speech application; or
send a second frame identifier of an end key frame in the key frame to the second speech application.

15. The electronic device of claim 13, wherein, when extracting the first audio data from the audio data according to the key frame, the processor is configured to:
determine a start key frame or an end key frame in the key frame;
determine a first extraction start frame based on the start key frame or the end key frame; and
obtain the first audio data by extracting a first preset duration of audio frames from the audio data based on the first extraction start frame.

16. The electronic device of claim 15, wherein when determining the first extraction start frame based on the start key frame or the end key frame, the processor is configured to:
determine any one of the start key frame and the end key frame as the first extraction start frame; or
determine the first extraction start frame by moving forward or backward a first preset number of frames from either the start key frame or the end key frame.

17. The electronic device of claim 15, wherein when determining the first extraction start frame based on the start key frame or the end key frame, the processor is configured to:
obtain recognition configuration information of the second speech application; and
determine a target key frame from the start key frame and the end key frame based on the recognition configuration information, and determine the first extraction start frame based on the target key frame.

18. The electronic device of claim 13, wherein the processor is further configured to:
establish a communication link with the second speech application, wherein the communication link is used to transmit the frame identifier of the key frame and the first audio data.

19. A non-transitory computer-readable storage medium having computer instructions stored thereon, wherein the computer instructions are used to cause a computer to perform the method of claim 1.

20. A non-transitory computer-readable storage medium having computer instructions stored thereon, wherein the computer instructions are used to cause a computer to perform the method of claim 7.
